(19) United States
(12) Patent Application Publication
(10) Pub. No.: US 2014/0046756 A1
(43) Pub. Date: Feb. 13, 2014

(54) GENERATIVE MODEL FOR RELATED SEARCHES AND ADVERTISING KEYWORDS

(71) Applicants: Joseph WANG, Burbank, CA (US); David B. JOHNSON, San Marino, CA (US)

(72) Inventors: Joseph WANG, Burbank, CA (US); David B. JOHNSON, San Marino, CA (US)

(73) Assignee: Shopzilla, Inc.

(21) Appl. No.: 13/569,727

(22) Filed: Aug. 8, 2012

(51) Int. Cl. G06Q 30/02

(52) U.S. Cl. 705/14.45; 705/14.4; 705/14.72

(57) ABSTRACT

Methods, systems, and apparatuses, including computer programs encoded on computer-readable media, for extracting n-grams from a plurality of offers. Each offer includes a title and price. The n-grams are filtered by bid data and phrase. For each of the remaining n-gram, the plurality of offers are searched to provide offer search results. The n-grams are filtered by offers based upon the offer search results, and the filtered n-grams are provided. The filtered n-grams can be used as search hints, related searches, or advertising keywords.

### BACKGROUND

Users can reach a specific website by typing a website URL into a browser's address bar, clicking on web search links on search engine result pages, clicking on advertisement links, or clicking on links on some content pages. The advertisement links showed next to web search links are called sponsored search ads. For sponsored search ads, search engines match users' queries and profiles against keywords associated with ads to determine a candidate set. The search engines may apply filtering and ranking to the candidate set in order to select the likely top monetizing ads since there are limited sponsored search ad spots. For ads to be included in a candidate set, the keywords associated with the ads need to match users' queries. Thus, advertisers need to select which keywords to use. That is, advertisers select various keywords that can cause their ads to be displayed to users. Generally, keywords should be related to advertiser's product and service. However, researching related keywords and generating ad creatives can be very time consuming. These tasks are routinely done manually by an ad agency or internal traffic acquisition personal. For an advertiser that has numerous products to market, such a manual approach is not scalable nor economically feasible. For web search links, the search engines index web pages and rank pages that match users' queries and profiles. One way for a website to expose additional pages to search engine crawlers to be indexed is to provide links to similar pages, where similar pages are those containing similar concepts, key phrases, keywords, link structures, etc to the original crawled pages. Related searches is one such example. Related searches can also help users find similar products and content or navigate to desired pages quicker.

### SUMMARY

In general, one aspect of the subject matter described in this specification can be embodied in a method for extracting n-grams from a plurality of offers. Each offer includes a title and price. The n-grams are filtered by bid data and phrase. For each of the remaining n-gram, the plurality of offers are searched to provide offer search results. The n-grams are filtered by offers based upon the offer search results, and the filtered n-grams are provided. The filtered n-grams can be used as search hints, related searches, or advertising keywords. Other implementations of these aspects include corresponding systems, apparatuses, and computer-readable media configured to perform the actions of the method.

The foregoing summary is illustrative only and is not intended to be in any way limiting. In addition to the illustrative aspects, implementations, and features described above, further aspects, implementations, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

FIG. 1 illustrates a search engine system in accordance with an illustrative implementation.

FIG. 2 is a block diagram of using offers to generate advertising keywords, related searches, and search hints in accordance with an illustrative implementation.

FIG. 3 is a flow diagram for determining a filtered list of n-grams in accordance with an illustrative implementation.

FIG. 4 is a flow diagram of determining if an n-gram should be filtered in accordance with an illustrative implementation.

FIG. 5 is a block diagram of a computer system in accordance with an illustrative implementation.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

This specification describes various techniques to generate, from one or more data sources, a list of n-grams that can be used as suggested related searches, advertising keywords, search hints, etc. Data sources can include, but are not limited to, catalogues, inventory databases, merchant databases, aggregated data feeds, external product description feeds, advertisements, external APIs, offers of products/services, and/or web corpus. Various implementations are described below utilizing offers of products and/or services to generate the list of n-grams. Other implementations can be implemented using any combination of data sources that include product information to generate the list of n-grams. In one implementation, n-grams can be generated based upon a listing of active offers for goods and services. For example, a website may provide an interface for users to search various offers from multiple vendors that are currently for sale. Titles and descriptions associated with the products are examples of data that can be used to generate n-grams. The number of n-grams that can be generated from the titles and descriptions can be large. Intelligently filtering the initial list of n-grams provides a relevant list of n-grams. For example, suggested advertising keywords can be generated. In addition to suggested advertising keywords, an advertisement, e.g., an ad creative, for a particular suggested keyword can be generated using titles, descriptions, prices, and shopping attributes associated with the offers whose data helped generate the suggested advertising keyword.

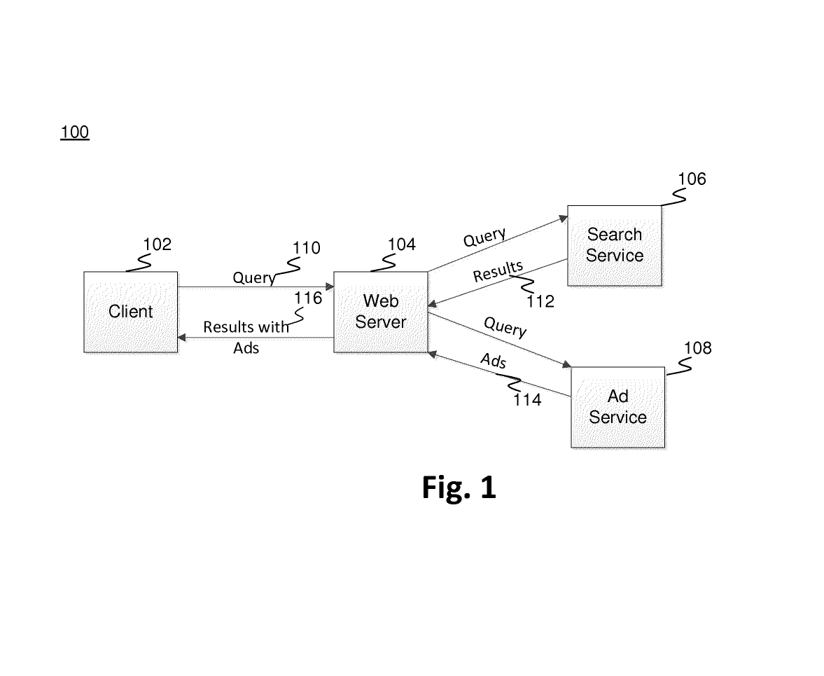

FIG. 1 illustrates a search engine system 100 in accordance with an illustrative implementation. A client 102, such as but not limited to, a web browser, can request information from a web server 104. In one implementation, a search query 110 containing keywords is used to retrieve search results. The web server 104 can pass the query 110 to one or more services. For example, the query 110 can be sent to a search service 106 that provides results 112 that are relevant to the query. The results 112 can include links to additional content, related searches, etc. The query 110 can also be used by an advertising service 108 that selects advertisements 114 related to the query 110. The advertising service 108 can also use various other information related to the client 102 or the user of the client 102 to select relevant advertisements. In addition, the advertising service 108 can use bids on keywords in the query from various advertisers to select advertisements. Some sites use an auction process to determine how much particular advertisers are willing to pay for placement of their keywords. These bids are additional data the advertising service 108 can use in selecting advertisements. The web server 104 or some intermediary server can combine the results 112 with the advertisements 114 and provide the combined results 116 to the client. In addition, the web server 104 can also provide the user with search hints based upon a partially input query. For example, if the user types in “blue je” the web server can suggest the complete search term “blue jeans.” The various services are shown as separate services/components, but can be combined within one or more computing devices.

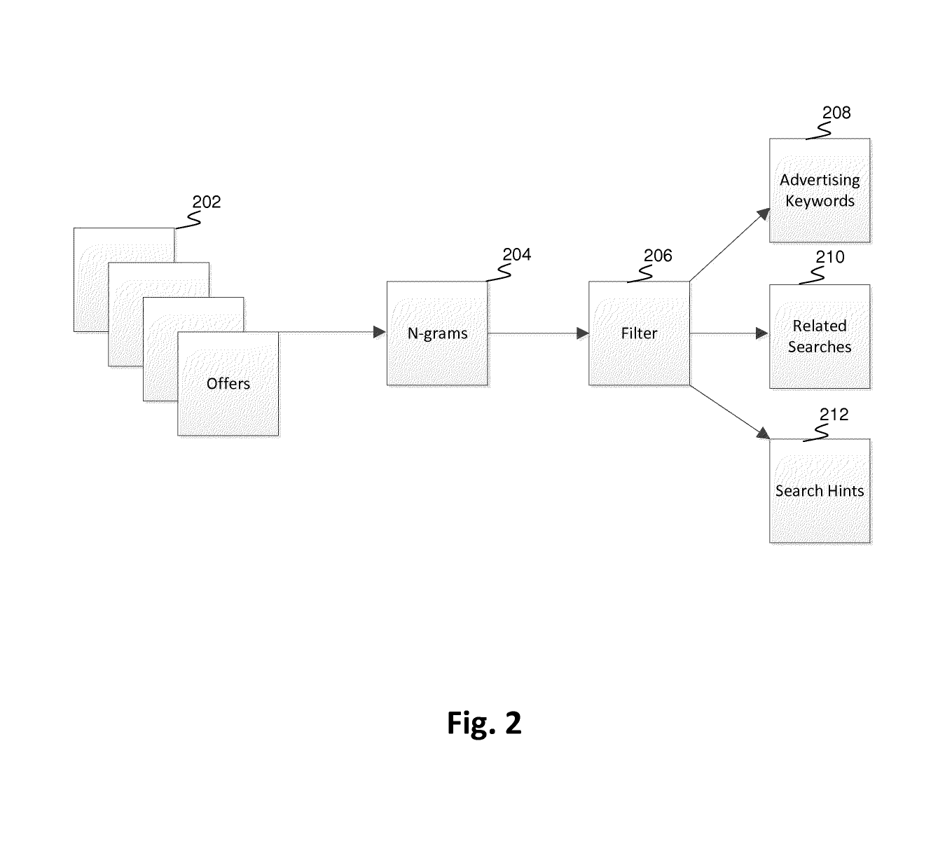

As noted above, determining advertising keywords can be a time consuming process. In one implementation, advertising keywords related to a website's current contents can be derived. In addition, the content can be used to derive related searches, search hints, and advertisements. FIG. 2 is a block diagram showing a system in which offers are used to generate advertising keywords, related searches, and search hints in accordance with an illustrative implementation. In one implementation, content includes a number of offers 202. The offers can be provided by third parties, such as merchants, that can include information about a good or service that is for sale. Each offer includes information such as a title, description, price, etc. In one implementation, the titles of the offers are used to generate n-grams 204. In other implementations, one or more of titles, descriptions, brands, merchants, product-nouns, category information, and other offer related information can be used to generate the n-grams 204. The number of n-grams generated from the offers is likely to be large and require paring down to find what are perceived to be the most useful/valuable n-grams. Accordingly, the n-grams can be filtered by various means 206. After filtering, the filtered n-grams can be used for various purposes such as advertising keywords 208, related searches 210, and search hints 212. As the offers can change frequently, e.g., due to third parties adding more offers, editing existing offers, or removing offers, the filtered n-grams can be determined at frequent times. In one implementation, changes to the filtered n-grams from one or more previous runs can be identified. As described in greater detail below, the n-gram generation and filtering can be different depending how the n-grams will be ultimately used.

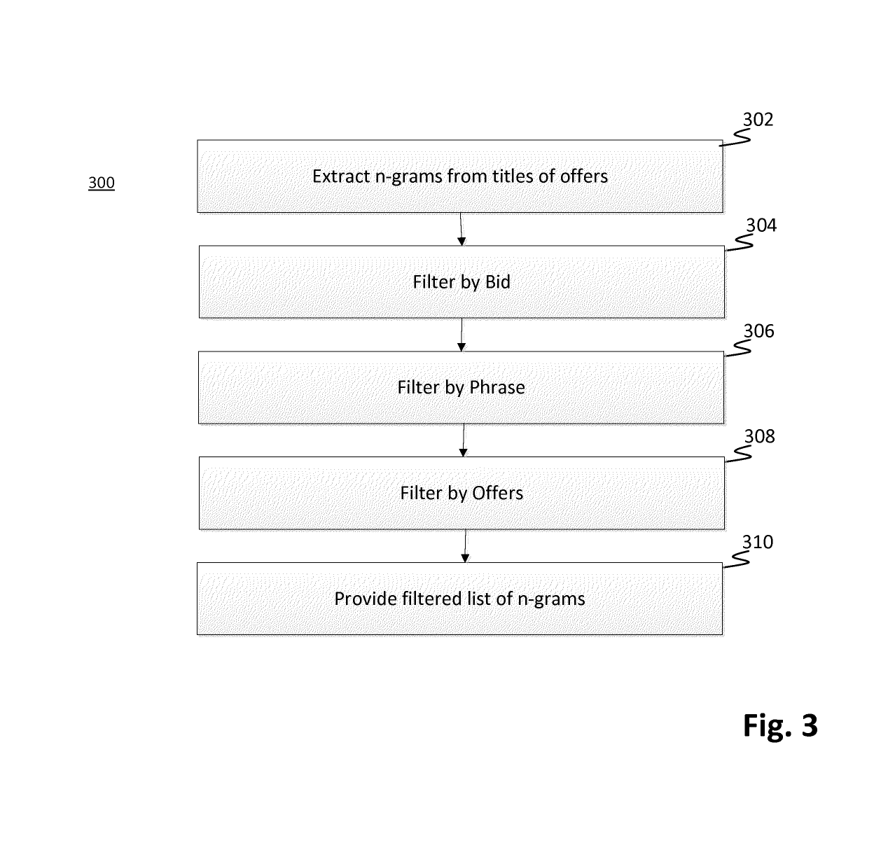

FIG. 3 is a flow diagram depicting operations for determining a filtered list of n-grams in accordance with an illustrative implementation. Additional, fewer, or different operations may be performed, depending on the particular embodiment. In an operation 302, n-grams are extracted from the titles of offers. The n-grams can be generated by breaking up the titles into components, e.g., words. In one implementation, stop words can be removed from titles prior to the title being broken up into components. For example, common words such as “the,” “a,” and “an” can be removed from the titles. The n-grams can consist of n components. Various values of n can be used, for example, but not limited to, 2, 3, 4, 5, 6, etc. The n-grams can be generated using a moving window. In one implementation, the n-grams are consecutive n-grams. That is, after breaking up the title into components, n-grams are generated without skipping any components from a title. As an example, an offer with a title of “ACME blue jeans” can be used to generate the n-grams of “ACME blue,” “ACME blue jeans,” and “blue jeans.” The n-gram “ACME jeans” will not be generated when consecutive n-grams are used. In another implementation, skipping of components is allowed. The n-grams, therefore, can include both consecutive and non-consecutive n-grams. The number of components that can be skipped can be limited, e.g., no more than four components can be skipped for any one n-gram. In the above example, “ACME jeans” would be a valid n-gram generated by skipping the component “blue.” In another implementation, n-grams can be generated using descriptions from the offers in addition to the titles. N-grams generated from the descriptions can be weighted less than n-grams generated from the titles.

An initial filtering can be applied to the set of n-grams based upon how often the n-gram occurs within the titles. N-grams that occur less than a predetermine number of times, e.g., 3, 5, 10, 20, etc., can be removed from the set of n-grams. In another implementation, the descriptions and titles can be searched for a particular n-gram.

The set of n-grams can be used to determine entities and/or shopping attributes. Shopping attributes include brand names, product, product lines, etc. The n-grams can be used to determine brand name (“ACME”), products (“blue jeans”), and product lines (“Great jeans”). As a detailed example, a list of brand names can be provided. Using this list brand names, n-grams that contain any brand name from the list can be found. The brand name can be removed from the n-grams and the remaining portions of the n-grams can be classified as potential products. Manual review or additional mining of future offers can be used to verify the potential product. Once identified as a product, the product can be stored and used to search for n-grams that contain the identified product. In a similar manner, a known list of products can be used to mine n-grams for unknown brand names. The n-grams that contain one or more words and then a known product can be found. The one or more words preceding the product name can be identified as a potential brand name. Manual review or future n-gram mining can be used to verify that the potential brand name is a valid brand name.

Returning to FIG. 3, the n-grams can also be used provide a list of filtered n-grams that can be used in various ways. As the number of n-grams generated from titles of offers in the operation 302 is likely large, the n-grams can be filtered in various ways. In an operation 304, the n-grams can be filtered by bid. For example, the n-grams can be treated as advertising keywords, and if any of the advertising keywords were previously bid upon by any advertisers can be determined. If there are no bids for one or more n-grams, they can be filtered out. In another implementation, the filtered n-grams must have more than a predetermined number of bids or an n-gram will be filtered out. The type of bid can also be used. For example, n-grams that do not have more than a predetermined number of pay-per-click bids can be removed. For example, this would remove an n-gram that had one or more pay-per-conversion bids but no pay-per-click bids.

Further filtering by phrases within the n-grams can occur in an operation 306. Filtering by phrases can include one or more of various types of filtering. For example, the parts of speech of each word of an n-gram can be determined. This can be determined by a parts of speech tagger prior to breaking the title up into components. N-grams that do not contain a noun can be removed. As another example, n-grams that have an adjective or stop word in the last position can be removed. Other n-grams can also be filtered, such as, but not limited to, n-grams with numbers not in the first position of the n-gram, contain punctuation, contain noisy words, etc. In one implementation noisy words includes one or more of verbs, adverbs, and/or prepositions. Additional filtering rules can be derived from editorial processes, machine learning models, category specific rules, or product specific business rules. The rules created from machine learning models can leverage historical performance metrics such as click-through rate, conversion rate, bounce rate, etc. The product specific business rules can filter certain n-grams that contain undesirable words or sub-phrases, and/or misspelled words

In an operation 308, filtering of the n-grams can continue by using the offers to further filter the list of n-grams. For example, each n-gram can be used to search the current offers to find matching offers. These matching offers can be used to further filter the n-grams. For example, the number of offers, the number of merchants, and the number of categories that are included in the matched offers can be used as criteria to filter n-grams. A top-category offer ratio, the number of offers within the top category compared to the rest of the offers, can also be used to filter the n-grams. Additional filtering, as described in greater detail below, can be applied based upon the ultimate use of the n-grams.

Additional filtering operations can be performed that are not shown in FIG. 3. For example, the filtering of the n-grams can continue by using search volume information from website's historical data, ad-network APIs, or other data sources. Search volumes for queries that match n-grams exactly may be weighted more than those from broad-match. Query “ACME jeans” will be considered exact match for an n-gram “ACME jeans.” Queries such as “ACME blue jeans” or “ACME jean” will be considered broad-match for an n-gram “ACME jeans.” N-grams that do not have sufficient high aggregated search volumes can also be removed. The aggregated search volume thresholds can be category specific to ensure each category has sufficient number of n-grams.

In addition, the n-grams can be filtered by using information associated with search results generated using an n-gram. For example, a search results webpage can be generated by searching a search engine with the n-gram. N-grams can be removed if the corresponding web page has lower quality or lower monetization potential.

Once filtered, the remaining n-grams can be provided in an operation 310. The n-grams can then be used in various ways, e.g., advertising keywords, related searches, search hints, etc.

Search Hints

In one implementation, the filtered list of n-grams can be used a list of potential complete searches that can be input by a user. When a user begins typing a query, the partial query can be matched against the filtered list of n-grams. Matching n-grams can be provided to the user as potentially complete searches. A user can then select one of the n-grams to complete their search rather than manually completing the search. In one implementation, the n-grams have been filtered to ensure that the n-grams will return a predetermined number of offers. Accordingly, the search hints ensure that a selected search hint will result in at least the predetermined number of offers.

Related Searches

In another implementation, the filtered list of n-grams can be used as related searches. Related searches are additional searches that are related to a received query. For example, a query for “ACME jeans” may have additional searches of “ACME jean shorts,” “ACME jeans white stitching,” and “ACME jean skirts.” In one implementation, the bid filtering of n-grams includes filtering any n-grams that do not have at least one bid associated with the n-gram. In addition, the offer filtering that uses the offers returned by searching the current offers with an n-gram can have various levels of filtering. For example, the n-gram can be filtered unless the number of offers returned in the results is more than or equal to 10, 20, 30, 50, etc., and the number of merchants is more than or equal to 3, 5, 7, 10, etc. To filter out generic n-grams, n-grams that have offers in more than 5, 10, 15, etc., categories can also be removed. The top-category offer ratio can also be used. N-grams whose top-category offer ratio is less than 0.4, 0.5, 0.55, 0.6, etc., can be filtered.

In addition to the above filtering, related searches can have an additional level of filtering. For example, the words of the n-grams can be stemmed and duplicative n-grams can be filtered out. Stemming the words allows for similar phrases that are different in a grammatical way, e.g., verb tense, plurality, etc., to be treated as the same. The language of the n-gram can also be determined and only certain languages can be kept. For example, n-grams that contain words from two or more languages can be removed from the list. After the filtering is done, the remaining n-grams can be stored as the universe of possible related searches that can be recommended to a user.

As noted above, related searches are provided in response to a received query. As a user interface can have a limited number of related searches that are shown to a user, ranking the related searches becomes important if there are more related searches for a particular query than what can be displayed in the user interface. In one implementation, related searches are ranked based upon shopping attributes of the related searches. For example, the number of common shopping attributes between the query and the related searches can be used to rank the related searches. For example, a user that searches for “ACME jeans” can be used to determine that the query contains a brand, “ACME”, and a product, “jeans.” The query can also be generalized as a query containing “brand product.” An initial list of related searches related to “ACME jeans” can be retrieved. Continuing this example, the related searches for “ACME jeans” can include “ACME blue jeans”; “ACME jean shorts”; “Ajax jeans”; “shorts”; and “socks.” The shopping attributes for these related searches can be used to rank the related searches. “ACME blue jeans”; “ACME jean shorts”; and “Ajax jeans” are similar to “ACME jeans” in that each of these related searches contain the shopping attributes brand and product. Accordingly, these search results can be ranked higher than “shorts” and “socks,” that would only have the shopping attribute product. Having the same brand name or product can also be used to rank the related searches. In one implementation, having the same brand name and/or product are used to rank related searches higher. In this implementation, the related searches are directed to similar products and other products with the same brand name. Alternatively, having a different brand and/or product can be used to rank those related search higher. In this implementation, the related searches are directed to more diverse results of different products or similar products of a different brand name.

Advertising Keywords

In another implementation, the filtered list of n-grams can be used as advertising keywords on other search engines. Advertising keywords are used to display advertisements that link to the site that contains the offers or to other sites. For example, based upon the title of current offers the advertising keywords of “ACME blue jeans” may be determined as a valuable keyword. In one implementation, the filtering applied to the set of n-grams is more restrictive compared to the filtering for related searches. For example, when filtering the n-grams by phrases, n-grams that contain any adjectives can be removed. Shopping characteristics can also be used to filter n-grams. In one implementation, shopping characteristics can include identifying colors and n-grams that include a color can be filtered.

In addition to the phrase filtering, the bid filtering of n-grams can include filtering any n-grams that do not have at least one bid associated with the n-gram. In another implementation, the bid filtering also includes filtering any n-grams that do not have at least one bid of a particular type, e.g., cost-per-click, cost-per-conversion, associated with the n-gram. In addition, the order filtering can include searching the offers with an n-gram and only including the n-grams that returned more than or equal to 30, 50, 75, 80, 100, etc., offers. In addition, the number of merchants contained within the returned offers can be determined and the n-gram can be filtered unless the number of merchants is more than or equal to 5, 8, 10, 12, etc. To filter out generic n-grams, n-grams that have offers in more than 3, 5, 10, etc., categories can also be removed. The top-category offer ratio can also be used. N-grams whose top-category offer ratio is less than 0.6, 0.75, 0.8, etc., can be filtered.

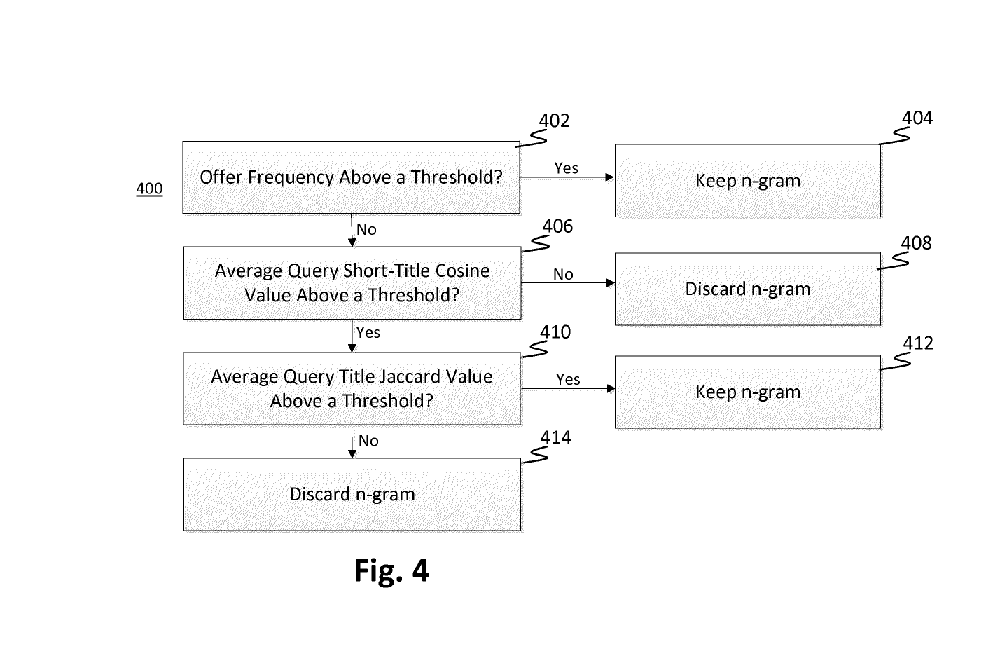

In addition to the above filtering, advertising keywords can have an additional level of filtering. For example, the keywords can be used to calculate query-offer scores. The query-offset scores can be used to filter keywords. FIG. 4 is a flow diagram of determining if an n-gram should be filtered in accordance with an illustrative implementation. FIG. 4 illustrates two different query-offer scores, average query short-title cosine and average query title Jaccard value. In an operation 402, the number of offers that are returned based upon searching the offers with the keyword is determined. This operation is similar to one of the filters as applied in the operation 308 of FIG. 3 and described above. If the number of offers is above an offer threshold the n-gram is kept, in an operation 404. If the number of offers is below the offer threshold, the average query short-title cosine value is calculated and determined to be above or below a cosine threshold value, in an operation 406. Generally, the average query short-title cosine value is a measure of how similar the n-gram is to the titles of the returned offers. The average query short-title cosine value can be calculated as the average score for each offer that is returned. The cosine threshold value can vary based upon the n-grams. The cosine threshold value can be, but is not limited to, 0.15, 0.2, 0.235, 0.25, 0.33, etc. In an operation 408, the average query short-title cosine value is below the cosine threshold and the n-gram is filtered from the set. If the average query short-title cosine value is above or equal to the cosine threshold, the average query title Jaccard score is calculated and compared to a Jaccard threshold value, in an operation 410. The average query title Jaccard score is another measure of how similar the n-gram is to the titles of the returned offers. The average Jaccard score can be calculated as the average score for each offer that is returned. The Jaccard threshold value can vary based upon the n-grams. The Jaccard threshold value can be, but is not limited to, 0.15, 0.2, 0.2, 0.25, 0.33, etc. In an operation 414, the n-gram is discarded for having an average query title Jaccard score that is below the Jaccard threshold. The n-gram is not filtered if the average query title Jaccard score that is above or equal to the Jaccard threshold, in an operation 412. In one implementation, n-grams that had offers above the offer threshold are ranked ahead of n-grams that had offers below the offer threshold but had average query short-title cosine values and average query title Jaccard scores that were above their respective thresholds.

Other query-offer scores can be used in filtering the n-grams. For example, first and second position query title cosine/Jaccard scores, first and second position bids, discounted cumulative gain scores, offers topic/category consistency scores, etc.

As another example, a query-offer score can be calculated as the following:

(offer count/merchant count)*(offer count/category count)/(last month impressions+1)*minimum bid,

where minimum bid is the lowest bid used to place an advertisement.

In this implementation, the remaining n-grams are advertising keywords. Using historical data, a search engine keyword performance metric can be calculated and used to rank the advertising keywords. This performance metric can be calculated for advertising keywords that were used in the historical data as well as for advertising keywords that were never used in the historical data. The performance metric can be used to determine a suggested bid value or suggested bid range for a particular search engine keyword. In various implementations, n-grams can be filtered out if they do not meet one or more performance metric thresholds such as, but not limited to, out of bid range, potential negative impact on overall site quality, ad quality, etc.

In one implementation, shopping characteristics for the keywords are used to calculate the performance metric. As an example, a determined search engine keyword can be “ACME Best jeans,” where ACME is the brand name, Best is the product line, and jeans is the product. Using known shopping characteristics, the “ACME Best jeans” keyword can be treated as a keyword that contains “brand name product line product.” Historical keywords can be searched that are similar to the shopping characteristics of “ACME Best jeans.” Continuing the current example, the historical data can include the following keywords “ACME Best jeans”; “ACME jeans”; “ACME OK jeans”; and “AJAX Great jeans”. The three keywords that have the same type of shopping characteristics to “ACME Best jeans” are “ACME Best jeans”; “ACME OK jeans”; and “AJAX Great jeans.” The value of the shopping characteristics can be used to determine what is the best matching keyword, which in the above example is the same keyword “ACME Best jeans.” Historical performance of this keyword can be used to calculate the performance metric for the actual keyword. In one implementation, the performance metric can be the click through ratio, the conversion rate of the keyword, or the revenue per search using the keyword.

In the above example, the historical performance data for the search engine keyword was used. The performance metric can still be calculated for keywords that are not part of the historical data. Using the same search engine keyword as above, “ACME Best jeans”, which may represent a brand new product line of jeans from ACME. Accordingly, the historical data may include the following keywords “ACME jeans”; “ACME OK jeans”; and “AJAX Great jeans”. The two keywords that have the same type of shopping characteristics to “ACME Best jeans” are “ACME OK jeans” and “AJAX Great jeans.” Historical keywords that include the same brand name and product can be used as a model to how the new search engine keyword will perform. In this example, this historical data for “ACME OK jeans” can be used to calculate the performance metric for “ACME Best jeans.” In another implementation, the historical data for “ACME OK jeans” can be combined with the historical data for “ACME jeans.” In this implementation, historical data for any keywords that have the same brand name and product can be used, even if the keyword does not include a product line.

As described above, the offers can be used to generate a set of advertising keywords. The offers can also be used to generate the actual text advertisement to display for particular advertising keywords. Advertising templates for particular products and/or brands can be used and populated with data from current offers. For example, there may be offers from one or more merchants for “ACME Best jeans.” These offers can include sale prices that range from $49.99 to $69.99. An exemplary advertising template can be “Buy PRODUCT LINE PRODUCT for as low as LOW!” Using the offers, the advertisement “Buy Great jeans for as low as $49.99!” can be created. Other shopping attributes such as the brand name, lowest price, average price, number of offers, number of merchants, if coupons are available, if sales are ongoing, etc., can be integrated into advertisements.

In another implementation, a set of advertising keywords can be grouped into conceptual units, and an advertisement can be generated for the set of the advertising keywords based upon the conceptual units. The set of advertising keywords can be generated from keywords that have the same values for one or more shopping attributes. For example, a brand-product conceptual unit can be used. Keywords such as “ACME boot cut jeans”; “ACME blue jeans”; and “ACME Great jeans” can be combined into the set of advertising keywords since each of these keywords has the same brand name and product. A single advertisement can then be generated for each of these keywords as described above.

In another implementation, the offer data can be integrated into graphical advertisements. The search engine keyword and associated created advertisement can be submitted to one or more search engines, to facilitate the purchasing of those keywords on the one or more search engines. Accordingly, advertising keywords and advertisements can be generated by mining the offer data.

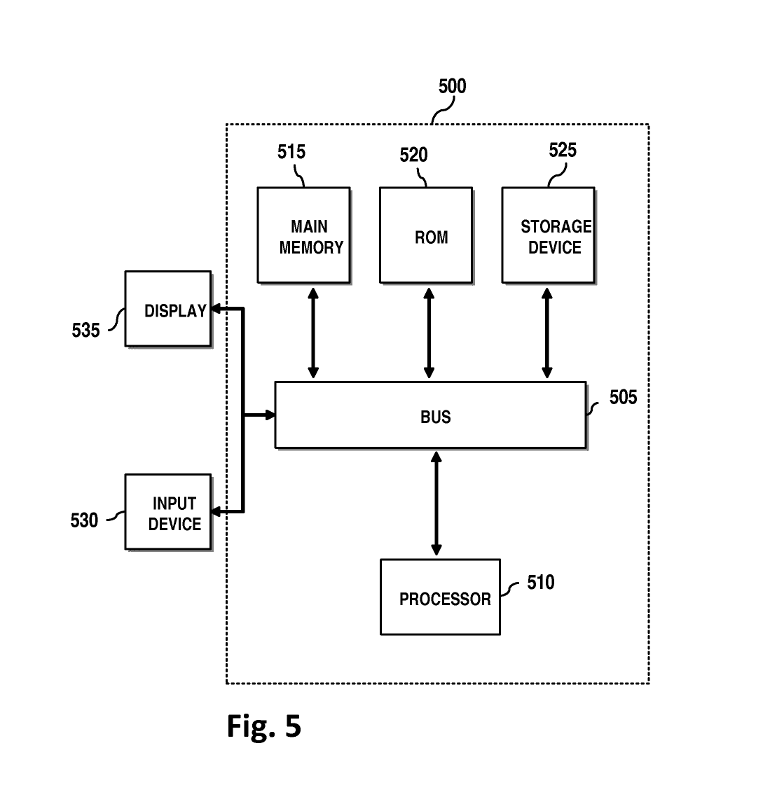

FIG. 5 is a block diagram of a computer system in accordance with an illustrative implementation. The computing system 500 can be used to implement the web server, search service, ad service, etc., and includes a bus 505 or other communication component for communicating information and a processor 510 or processing circuit coupled to the bus 505 for processing information. The computing system 500 can also include one or more processors 510 or processing circuits coupled to the bus for processing information. The computing system 500 also includes main memory 515, such as a random access memory (RAM) or other dynamic storage device, coupled to the bus 505 for storing information, and instructions to be executed by the processor 510. Main memory 515 can also be used for storing position information, temporary variables, or other intermediate information during execution of instructions by the processor 510. The computing system 500 may further include a read only memory (ROM) 510 or other static storage device coupled to the bus 505 for storing static information and instructions for the processor 510. A storage device 525, such as a solid state device, magnetic disk or optical disk, is coupled to the bus 505 for persistently storing information and instructions.

The computing system 500 may be coupled via the bus 505 to a display 535, such as a liquid crystal display, or active matrix display, for displaying information to a user. An input device 530, such as a keyboard including alphanumeric and other keys, may be coupled to the bus 505 for communicating information and command selections to the processor 510. In another implementation, the input device 530 has a touch screen display 535. The input device 530 can include a cursor control, such as a mouse, a trackball, or cursor direction keys, for communicating direction information and command selections to the processor 510 and for controlling cursor movement on the display 535.

According to various implementations, the processes described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the invention have been described. Other implementations are within the scope of the following claims. In some cases, the actions recited in the claims can be performed in a different order and still achieve desirable results.

What is claimed is:

1. A method comprising:
extracting, using a processor, n-grams from a plurality of offers, wherein each offer comprises a title and price;
filtering the n-grams by bid data;
filtering the n-grams by phrase;
for each remaining n-gram:
searching the plurality of offers to provide offer search results; and
filtering the each remaining n-gram by offers based upon the offer search results; and
providing the filtered n-grams.

2. The method of claim 1, wherein filtering the n-grams by bid data comprises:
determining if an n-gram has any current advertising bids; and
filtering the n-gram if the n-gram does not have any current advertising bids.

3. The method of claim 2, wherein filtering the n-grams by phrase comprises:
determining the part of speech for each word within an n-gram; and
filtering the n-gram if the n-gram does not contain a noun.

4. The method of claim 3, wherein filtering the n-grams by offers based upon the offer search results comprises:
determining a number of offers, a number of categories, and a number of merchants are contained within the offer search results;
filtering the each remaining n-gram when the number of offers below an offer threshold;
filtering the each remaining n-gram when the number of categories above a category threshold; and
filtering the each remaining n-gram when the number of merchants is below a merchant threshold.

5. The method of claim 4, wherein the filtered n-grams are search hints.

6. The method of claim 4, wherein the filtered n-grams are related searches.

7. The method of claim 6, further comprising:
for each filtered n-gram:
determining one or more languages used in the each filtered n-gram; and
removing the each filtered n-gram from the filtered n-grams based upon the one or more languages; and
deduping the filtered n-grams.

8. The method of claim 3, wherein filtering the n-grams by offers based upon the offer search results comprises:
determining a number of offers, a number of categories, and a number of merchants are contained within the offer search results;
filtering the each remaining n-gram when the number of categories above a category threshold; and
filtering the each remaining n-gram when the number of merchants is below a merchant threshold.

9. The method of claim 8, wherein the filtered n-grams are advertising keywords.

10. The method of claim 9, further comprising:
searching the offers using one of the filtered keywords to produce keyword offer results;
generating a text advertisement for the one of the filtered keywords that includes a price based upon the prices of the offers contained with the keyword offer results.

11. The method of claim 9, further comprising:
determining the number of offers is below an offer threshold;
calculating a first query-offer score;
filtering the each remaining n-gram when the first query-offer score is below a first threshold;
calculating a second query-offer score; and
filtering the each remaining n-gram when the second query-offer score is below a second threshold.

12. The method of claim 11, wherein the first query-offer score is an average query short-title cosine score and the second query-offer score is an query title Jaccard value.

13. The method of claim 9, further comprising:
determining shopping attributes for each filtered keyword, wherein the shopping attributes include a brand name, a product line, and a product;
determining shopping attributes for each historical keyword in historical data;
for each filtered keyword:
determining one or more related keywords based upon the shopping attributes of the filtered keyword and the shopping attributes of the historical keywords; and
calculating a performance metric based upon the one or more related keywords.

14. The method of claim 13, wherein determining the one or more related keywords comprises:
determining the each filtered keyword includes a brand and a product;
finding historical keywords that include a brand and a product; and
selecting historical keywords, as the one or more related keywords, that have a same brand and a same product as the each filtered keyword.

15. A non-transitory computer-readable medium having instructions stored thereon, that when executed by a computing device cause the computing device to perform operations comprising:
extracting n-grams from a plurality of offers, wherein each offer comprises a title and price;
filtering the n-grams by bid data;
filtering the n-grams by phrase;
for each remaining n-gram:
searching the plurality of offers to provide offer search results; and
filtering the each remaining n-gram by offers based upon the offer search results; and
providing the filtered n-grams.

16. The non-transitory computer-readable medium of claim 16, wherein the filtered n-grams are related searches.

17. The non-transitory computer-readable medium of claim 16, wherein the filtered n-grams are advertising keywords.

18. A system comprising:
one or more electronic processors configured to:
extract n-grams from a plurality of offers, wherein each offer comprises a title and price;
filter the n-grams by bid data;
filter the n-grams by phrase;
for each remaining n-gram:
search the plurality of offers to provide offer search results; and
filter the each remaining n-gram by offers based upon the offer search results; and
provide the filtered n-grams.

19. The system of claim 18, wherein the filtered n-grams are related searches.

20. The system of claim 19, wherein the filtered n-grams are advertising keywords.
